(19) United States
(12) Patent Application Publication
(10) Pub. No.: US 2023/0024747 A1
(43) Pub. Date: Jan. 26, 2023

(54) SEALANT COMPOSITION

(71) Applicant: DOW SILICONES CORPORATION, Midland, MI (US)

(72) Inventors: Xiuyan WANG, Shanghai (CN); Jiang PENG, Shanghai (CN); Yi GUO, Shanghai (CN); Qiang HU, Shanghai (CN); Zhiping ZENG, Shanghai (CN); Nanguo LIU, Midland, MI (US); Nick SHEPHARD, Auburn, MI (US)

(21) Appl. No.: 17/786,418

(22) PCT Filed: Dec. 17, 2019
(86) PCT No.: PCT/CN2019/125817

§ 371 Date: Jun. 16, 2022

(51) Int. Cl. C09J 183/04; C08K 9/06; C08K 5/54; C08K 5/09; C08K 3/26

(52) U.S. Cl. CPC C09J 183/04; C08K 9/06; C08K 5/54; C08K 5/09; C08K 3/26; C08K 2003/265

(57) ABSTRACT

A one-part low modulus room temperature vulcanisable (RTV) silicone composition containing a catalyst comprising (i) a titanate and/or zirconate and (ii) a metal carboxylate salt which cures to a low modulus silicone elastomer which may be used as a non-staining (clean) sealant having high movement capability.

This relates to a one-part low modulus room temperature vulcanisable (RTV) silicone composition containing a catalyst comprising (i) a titanate and/or zirconate and (ii) a metal carboxylate salt which cures to a low modulus silicone elastomer which may be used as a non-staining (clean) sealant having high movement capability.

Room temperature vulcanizable (RTV) silicone rubber compositions (hereinafter referred to as “RTV compositions”) are well known. Generally, such compositions comprise an —OH end-blocked diorganopolysiloxane polymer or an alkoxy end-blocked polydiorganosiloxane which may have an alkylene link between the end silicon atoms and one or more suitable cross-linking agents designed to react with the —OH and/or alkoxy groups and thereby cross-link the composition to form an elastomeric sealant product. One or more additional ingredients such as catalysts, reinforcing fillers, non-reinforcing fillers, diluents (e.g. plasticisers and/or extenders), chain extenders, flame retardants, solvent resistant additives, biocides and the like are often also incorporated into these compositions as and when required. They may be one-part compositions or multiple-part compositions. One-part compositions are generally stored in a substantially anhydrous form to prevent premature cure. The main, if not sole source, of moisture in these compositions are the inorganic fillers, e.g. silica when present. Said fillers may be rendered anhydrous before inter-mixing with other ingredients or water/moisture may be extracted from the mixture during the mixing process to ensure that the resulting sealant composition is substantially anhydrous.

Silicone sealant compositions having at least one Si-alkoxy bond, e.g. Si-methoxy bond in the terminal reactive silyl group and having a polydiorganosiloxane polymeric backbone are widely used for sealants in the construction industry because they have low viscosity and good moisture permeability, adhesion, and weather resistance, and the like. Such sealants are often required to provide low-modulus cured products capable of being highly stretched by a small amount of stress. The construction industry also prefers one-component compositions to negate the need for mixing ingredients before application and compositions with excellent workability.

Low modulus room temperature vulcanisable (RTV) silicone compositions can be used in a wide variety of applications. For example, they have achieved considerable commercial success as highway sealants and more recently in the building construction industry. In certain applications, such as the construction of high-rise buildings, it is desirable and often critical to utilize low modulus sealants and/or adhesives for adhering window panes to the frames (metal or otherwise) of a building structure. The low modulus property enables the resulting cured silicone elastomers to easily compress and expand with building movement due to winds and the like without causing cohesive or adhesive failure.

Indeed recent architectural trends towards “mirrored” high rise buildings, that is, high rise buildings where the exterior of the building has the appearance of being a large mirror, for both aesthetic and energy-saving reasons, have resulted in there being a great deal of interest in providing suitable low modulus silicone sealants to deliver such effects.

Low modulus sealants typically rely on high molecular weight/chain length polydiorganosiloxane polymers which are end-blocked with reactive groups but have low levels of reactive groups attached to silicon atoms along the polymer chain in order to generate cross-linked elastomeric products with low cross-link densities. Such polymers have often been prepared using chain extension processes for which suitable reactive silanes may be utilised as chain extenders during the curing of the composition. However, the use of such high molecular weight polymers typically results in high viscosity compositions especially when reinforcing fillers are also introduced into the composition.

Reinforcing fillers make important contributions to both the cost and rheology of compositions and to the physical properties of resulting elastomeric materials formed from the composition upon cure, such as, abrasion resistance, tensile and tear strength, hardness and modulus. For example, fine particle fumed silicas are used in compositions from which silicone sealants are made in order to improve strength in the cured elastomer. Inclusion of filler as well as the high molecular weight polymers in a liquid composition leads to stiffening of the composition and a reduction in flowability of the composition, and consequently to a need for increased applied shear during mixing to achieve the desired homogenous mixed state of the composition as greater amounts of filler are used. This can be a major problem in room temperature cure materials which are often sought to be gunnable i.e. applied by means of pushing uncured sealant out of a sealant tube using a sealant gun.

The introduction of unreactive liquid plasticisers/extenders (sometimes referred to as process aids) has been utilised to produce low modulus sealants. They are used as a means of lowering viscosity of uncured compositions. However, once cured the unreactive liquids within the cured sealant may migrate and potentially bleed out of the sealant which, over an extended period of time, can result in the sealant failing and often causes staining and discoloration in/on adjacent substrates.

Another known problem is seen when tin (iv) catalysts are used in the sealant compositions as the resulting elastomers, upon cure, tend to lose the ability to expand and recover as e.g. a building moves due to e.g. weather conditions over extended life times. This type of product cannot follow the expansion and shrinkage as the low-modulus sealants are often found to have lower recovery properties than high-modulus sealants.

It is well known to people skilled in the art that alkoxy titanium compounds—i.e. alkyl titanates—are suitable catalysts for formulating one component moisture curable silicones (References: Noll, W.; Chemistry and Technology of Silicones, Academic Press Inc., New York, 1968, p. 399, Michael A. Brook, silicon in organic, organometallic and polymer chemistry, John Wiley & sons, Inc. (2000), p. 285). Titanate catalysts have been widely described for their use in skin/diffusion cured one-part condensation curing silicone compositions. Skin or diffusion cure (e.g. moisture/condensation) occurs by the initial formation of a cured skin at the composition/air interface subsequent to the sealant/encapsulant being applied on to a substrate surface. Subsequent to the generation of the surface skin the cure speed is dependent on the speed of diffusion of moisture from the sealant/encapsulant interface with air to the inside (or core), and the diffusion of condensation reaction by-product/effluent from the inside (or core) to the outside (or surface) of the material and the gradual thickening of the cured skin over time from the outside/surface to the inside/core. These compositions are typically used in applications where in use the composition is applied in layers of ≤15 mm. Layers thicker than 15 mm are known to result in uncured material being present in the depth of the otherwise cured elastomer because moisture is very slow to diffuse into very deep sections.

The disclosure herein seeks to provide a one-part low modulus room temperature vulcanisable (RTV) silicone composition, which upon cure provides a sealant with a low modulus e.g. ≤0.4 MPa at 100% elongation and is non-staining (clean) with respect to porous substrates like granite, limestone, marble, masonry, metal and composite panels.

There is provided herein a one-part condensation curable low modulus room temperature vulcanisable (RTV) silicone composition comprising
(a) an organopolysiloxane polymer having at least two hydroxyl or hydrolysable groups per molecule of the formula

X₃₋ₙRₙSi—(Z)_{d}—(O)_{q}—(R¹_{y}SiO_{(4-y)/2})_{z}—(SiR¹₂₋Z)_{d}—Si—RₙX₃₋ₙ (1)
in which each X is independently a hydroxyl group or a hydrolysable group, each R is an alkyl, alkenyl or aryl group, each R¹ is X group, alkyl group, alkenyl group or aryl group and Z is a divalent organic group;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 80,000 mPa·s at 25° C., alternatively from 40,000 to 75,000 mPa·s at 25° C., in an amount of from 35 to 60% by weight of the composition;
(b) a hydrophobically treated reinforcing filler in an amount of 30 to 55% by weight of the composition;
(c) one or more difunctional silanes in an amount of from 0.5 to 5% by weight of the composition;
(d) a catalyst comprising (i) a titanate and/or zirconate and (ii) a metal carboxylate salt;
(e) an adhesion promoter in an amount of 0.1-1% by weight of the composition; and
(f) one or more reactive silanes having at least 3 functional groups in an amount of from 0 to 3% by weight of the composition.

There is also provided herein a method of making the above composition by mixing all the ingredients together.

There is also provided herein an elastomeric sealant material which is the cured product of the composition as hereinbefore described.

There is also provided a use of the aforementioned composition as a sealant in the facade, insulated glass, window construction, automotive, solar and construction fields.

There is also provided a method for filling a space between two substrates so as to create a seal therebetween, comprising:
a) providing a silicone composition as hereinbefore described, and either
b) applying the silicone composition to a first substrate, and bringing a second substrate in contact with the silicone composition that has been applied to the first substrate, or
c) filling a space formed by the arrangement of a first substrate and a second substrate with the silicone composition and curing the silicone composition.

The concept of “comprising” where used herein is used in its widest sense to mean and to encompass the notions of “include” and “consist of”.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

The compositions are preferably room temperature vulcanisable compositions in that they cure at room temperature without heating but may if deemed appropriate be accelerated by heating.

Organopolysiloxane polymer (a) having at least two hydroxyl or hydrolysable groups per molecule has the formula

X₃₋ₙRₙSi—(Z)_{d}—(O)_{q}—(R¹_{y}SiO_{(4-y)/2})_{z}—(SiR¹₂₋Z)_{d}—Si—RₙX₃₋ₙ (1)
in which each X is independently a hydroxyl group or a hydrolysable group, each R is an alkyl, alkenyl or aryl group, each R¹ is an X group, alkyl group, alkenyl group or aryl group and Z is a divalent organic group;
d is 0 or 1, q is 0 or 1 and d+q=1; n is 0, 1, 2 or 3, y is 0, 1 or 2, and z is an integer such that said organopolysiloxane polymer (a) has a viscosity of from 30,000 to 80,000 mPa·s at 25° C., alternatively from 40,000 to 75,000 mPa·s at 25° C., in accordance with ASTM D 1084-16 using a Brookfield rotational viscometer with spindle CP-52 at 1 rpm.

Each X group of organopolysiloxane polymer (a) may be the same or different and can be a hydroxyl group or a condensable or hydrolyzable group. The term “hydrolyzable group” means any group attached to the silicon which is hydrolyzed by water at room temperature. The hydrolyzable group X includes groups of the formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH_{3.}

The most preferred X groups are hydroxyl groups or alkoxy groups. Illustrative alkoxy groups are methoxy, ethoxy, propoxy, isopropoxy, butoxy, isobutoxy, pentoxy, hexoxy octadecyloxy and 2-ethylhexoxy; dialkoxy groups, such as methoxymethoxy or ethoxymethoxy and alkoxyaryloxy, such as ethoxyphenoxy. The most preferred alkoxy groups are methoxy or ethoxy. When d=1, n is typically 0 or 1 and each X is an alkoxy group, alternatively an alkoxy group having from 1 to 3 carbons, alternatively a methoxy or ethoxy group. In such a case organopolysiloxane polymer (a) has the following structure:

X₃₋ₙRₙSi—(Z)—(R¹_{y}SiO_{(4-y)/2})_{z}—(SiR¹₂₋Z)—Si—RₙX₃₋ₙ
with R, R¹, Z, y and z being the same as previously identified above, n being 0 or 1 and each X being an alkoxy group.

Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to 10 carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups aminoalkyl groups, polyaminoalkyl groups, and/or epoxyalkyl groups.

Each R¹ is individually selected from the group consisting of X or R with the proviso that cumulatively at least two X groups and/or R¹ groups per molecule are hydroxyl or hydrolysable groups. It is possible that some R¹ groups may be siloxane branches off the polymer backbone which branches may have terminal groups as hereinbefore described. Most preferred R¹ is methyl.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group.

Additionally n is 0, 1, 2 or 3, d is 0 or 1, q is 0 or 1 and d+q=1. In one alternatively when q is 1, n is 1 or 2 and each X is an OH group or an alkoxy group. In another alternative when d is 1 n is 0 or 1 and each X is an alkoxy group.

Organopolysiloxane polymer (a) has a viscosity of from 30,000 to 80,000 mPa·s at 25° C., alternatively from 40,000 to 75,000 mPa·s at 25° C., in accordance with ASTM D 1084-16 using a Brookfield rotational viscometer with spindle CP-52 at 1 rpm, z is therefore an integer enabling such a viscosity, alternatively z is an integer from 300 to 5000. Whilst y is 0, 1 or 2, substantially y=2, e.g. at least 90% alternatively 95% of R¹_{y}SiO_{(4-y)/2} groups are characterized with y=2.

Organopolysiloxane polymer (a) can be a single siloxane represented by Formula (1) or it can be mixtures of organopolysiloxane polymers represented by the aforesaid formula. Hence, the term “siloxane polymer mixture” in respect to organopolysiloxane polymer (a) is meant to include any individual organopolysiloxane polymer (a) or mixtures of organopolysiloxane polymer (a).

The Degree of Polymerization (DP), (i.e. in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by Gel permeation chromatography (GPC) with precision of about 10-15%. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity. Organopolysiloxane polymer (a) is present in the composition in an amount of from 35 to 60% by weight of the composition, alternatively 35 to 55%, alternatively 40 to 55% by weight of the composition.

The reinforcing filler (b) comprises one or more finely divided, reinforcing fillers such as precipitated calcium carbonate, ground calcium carbonate fumed silica, colloidal silica and/or precipitated silica including, for example, rice hull ash or a mixture thereof such as ground calcium carbonate with silica or precipitated calcium carbonate. Typically, the surface area of the reinforcing filler (b) is at least 15 m²/g in the case of precipitated calcium carbonate measured in accordance with the BET method (ISO 9277: 2010), alternatively 15 to 50 m²/g, alternatively 15 to 25 m²/g in the case of precipitated calcium carbonate. Silica reinforcing fillers have a typical surface area of at least 50 m²/g. In one embodiment reinforcing filler (b) is a precipitated calcium carbonate, precipitated silica and/or fumed silica; alternatively, precipitated calcium carbonate. In the case of high surface area fumed silica and/or high surface area precipitated silica, these may have surface areas of from 75 to 400 m²/g measured in accordance with the BET method (ISO 9277: 2010), alternatively of from 100 to 300 m²/g in accordance with the BET method (ISO 9277: 2010). The particle size of fumed Silica may be <50 nm for reinforcing fillers and/or typically 70-150 nm for semi-reinforcing fillers.

Typically, the reinforcing filler is present in the composition in an amount of from 30 to 55% by weight of the composition.

Reinforcing filler (b) is hydrophobically treated for example with one or more aliphatic acids, e.g. a fatty acid such as stearic acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other components. The surface treatment of the fillers makes them easily wetted by organopolysiloxane polymer (a) of the base component. These surface modified fillers do not clump and can be homogeneously incorporated into the organopolysiloxane polymer (a) of the composition. This results in improved room temperature mechanical properties of the uncured compositions. The fillers may be pre-treated or may be treated in situ when being mixed with organopolysiloxane polymer (a).

The composition herein also comprises at least one difunctional silane (c). The difunctional silanes (c) are utilised as cross-linkers and/or chain extenders for organopolysiloxane polymer (a).
The difunctional silanes may have the following structure

(R⁶)₂—Si—(R⁷)₂
Wherein each R⁶ may be the same or different but is a non-functional group, in that it is unreactive with the —OH groups or hydrolysable groups of organopolysiloxane polymer (a). Hence, each R⁶ group is selected from an alkyl group having from 1 to 10 carbon atoms, an alkenyl group, an alkynyl group or an aryl group such as phenyl. In one alternative the R⁶ groups are either alkyl groups or alkenyl groups, alternatively there may be one alkyl group and one alkenyl group per molecule. The alkenyl group may for example be selected from a linear or branched alkenyl groups such as vinyl, propenyl and hexenyl groups and the alkyl group has from 1 to 10 carbon atoms, such as methyl, ethyl or isopropyl.

Each group R⁷ may be the same or different and is reactable with the hydroxyl or hydrolysable groups. Examples of group R⁷ include alkoxy, acetoxy, oxime, hydroxy and/or acetamide groups. Alternatively, each R⁷ is either an alkoxy group or an acetamide group. When R⁷ is an alkoxy group, said alkoxy groups containing between 1 and 10 carbon atoms, for example methoxy, ethoxy, propoxy, isopropoxy, butoxy, and t-butoxy groups. Specific examples of suitable silanes for component (c) herein include, alkenyl alkyl dialkoxysilanes such as vinyl methyl dimethoxysilane, vinyl ethyldimethoxysilane, vinyl methyldiethoxysilane, vinylethyldiethoxysilane, alkenylalkyldioximosilanes such as vinyl methyl dioximosilane, vinyl ethyldioximosilane, vinyl methyldioximosilane, vinylethyldioximosilane, alkenylalkyldiacetoxysilanes such as vinyl methyl diacetoxysilane, vinyl ethyldiacetoxysilane, vinyl methyldiacetoxysilane, vinylethyldiacetoxysilane and alkenylalkyldihydroxysilanes such as vinyl methyl dihydroxysilane, vinyl ethyldihydroxysilane, vinyl methyldihydroxysilane and vinylethyldihydroxysilane.

When R⁷ is an acetamide the disiloxane may be a dialkyldiacetamidosilane or an alkylalkenyldiacetamidosilane. Such diacetamidosilanes are known chain extending materials for low modulus sealant formulations as described in for example U.S. Pat. Nos. 5,017,628 and 3,996,184. The diacetamidosilanes may for example have the structure

CH₃—C(═O)—NR³—Si(R²)₂—NR³—C(═O)—CH₃
wherein each R³ may be the same or different and may be the same as R as defined above, alternatively, each R³ may be the same or different and may comprise an alkyl group having from 1 to 6 carbons, alternatively 1 to 4 carbons. Each R² may also be the same or different and may also be the same as R as defined above comprise an alkyl group having from 1 to 6 carbons, alternatively 1 to 4 carbons or an alkenyl group having from 2 to 6 carbons, alternatively 2 to 4 carbons, alternatively vinyl. In use the diacetamidosilanes may be selected from one or more of the following:
N, N′-(dimethylsilylene)bis[N-methylacetamide]
N, N′-(dimethylsilylene)bis[N-ethylacetamide]
N, N′-(diethylsilylene)bis [N-methylacetamide]
N, N′-(diethylsilylene)bis[N-ethylacetamide]
N, N′-(dimethylsilylene)bis[N-propylacetamide]
N, N′-(diethylsilylene)bis[N-propylacetamide]
N, N′-(dipropylsilylene)bis[N-methylacetamide]
N, N′-(dipropylsilylene)bis[N-ethylacetamide]
N, N′-(methylvinylsilylene)bis[N-ethylacetamide]
N, N′-(ethylvinylsilylene)bis[N-ethylacetamide]
N, N′-(propylvinylsilylene)bis[N-ethylacetamide]
N, N′-(methylvinylsilylene)bis[N-methylacetamide]
N, N′-(ethylvinylsilylene)bis[N-methylacetamide] and/or
N, N′-(propylvinylsilylene)bis[N-methylacetamide].
In an alternative, the dialkyldiacetamidosilane may be a dialkyldiacetamidosilane selected from N, N′-(dimethylsilylene)bis[N-ethylacetamide] and/or N, N′-(dimethylsilylene)bis[N-methylacetamide]. Alternatively, the dialkyldiacetamidosilane is N, N′-(dimethylsilylene)bis[N-ethylacetamide].

The difunctional silanes (c) are present in an amount of from 0.5 to 5% by weight of the composition.

As hereinbefore described the catalyst (d) is a catalyst comprising (i) a titanate and/or zirconate and (ii) a metal carboxylate salt. The titanate and/or zirconate (i) in catalyst (d) chosen for inclusion in sealant composition as defined herein, depends upon the speed of cure required. Titanate and/or zirconate based catalysts may comprise a compound according to the general formula Ti[OR⁹]₄ or Zr[OR⁹]₄ where each R⁹ may be the same or different and represents a monovalent, primary, secondary or tertiary aliphatic hydrocarbon group which may be linear or branched containing from 1 to 10 carbon atoms. Optionally the Titanate and/or zirconate based catalysts may contain partially unsaturated groups. However, preferred examples of R⁹ include but are not restricted to methyl, ethyl, propyl, isopropyl, butyl, tertiary butyl and a branched secondary alkyl group such as 2, 4-dimethyl-3-pentyl. Preferably, when each R⁹ is the same, R⁹ is an isopropyl, branched secondary alkyl group or a tertiary alkyl group, in particular, tertiary butyl. Suitable examples include for the sake of example, tetra n-butyl titanate, tetra t-butyl titanate, tetra t-butoxy titanate, tetraisopropoxy titanate and diisopropoxydiethylacetoacetate titanate (as well as zirconate equivalents). Alternatively, the titanate/zirconate may be chelated. The chelation may be with any suitable chelating agent such as an alkyl acetylacetonate such as methyl or ethylacetylacetonate. Alternatively, the titanate may be monoalkoxy titanates bearing three chelating agents such as for example 2-propanolato, tris isooctadecanoato titanate.

In the present disclosure catalyst (d) also comprises (ii) a metal carboxylate salt wherein the metal is selected from one or more of zinc, aluminium, bismuth, iron and/or zirconium. The carboxylate groups are of the formula R¹⁵COO⁻ where R¹⁵ is selected from hydrogen, alkyl groups, alkenyl groups, and aryl groups. Examples of useful alkyl groups for R¹⁵ include alkyl groups having from 1 to 18 carbon atoms, alternatively 1 to 8 carbon atoms. Examples of useful alkenyl groups for R¹⁵ include alkenyl groups having from 2 to 18 carbon atoms, alternatively 2 to 8 carbon atoms such as vinyl, 2-propenyl, allyl, hexenyl, and octenyl. Examples of useful aryl groups for R¹⁵ include aryl groups having from 6 to 18 carbon atoms, alternatively 6 to 8 carbon atoms such as phenyl and benzyl. Alternatively, R¹⁵ is methyl, 2-propenyl, allyl, and phenyl. Hence the metal carboxylate salt (ii) in catalyst (e) may be zinc (II) carboxylates, aluminium (III) carboxylates, bismuth (III) carboxylates and/or zirconium (IV) carboxylates, zinc (II) alkylcarboxylates, aluminium (III) alkylcarboxylates, bismuth (III) alkylcarboxylates and/or zirconium (IV) alkylcarboxylates or mixtures thereof. Specific examples of metal carboxylate salt (ii) in catalyst (d) include, zinc ethylhexanoate, bismuth ethylhexanoate zinc stearate, zinc undecylenate, zinc neodecanoate, and iron (III) 2-ethylhexanoate. The titanate and/or zirconate (i) and metal carboxylate salt (ii) of catalyst (d) is provided in a molar ratio of 1:4 to 4:1.

The catalyst (d) is typically present in an amount of from 0.25 to 4.0% by weight of the composition, alternatively from 0.25 to 3% by weight of the composition, alternatively from 0.3% to 2.5% by weight of the composition.

Although not preferred, if deemed appropriate or necessary, optionally catalyst (e) may also additionally include a tin catalyst. The additional tin based condensation catalyst may be any catalyst suitable for catalysing the cure of the total composition. Said tin catalyst, if used, must be compatible with the other components of the catalyst (e).

The composition as hereinbefore described may also incorporate one or more adhesion promoters (e). Preferably the adhesion promoters (e) are aminosilane based. The aminosilanes may comprise:

(CH₃)ₙ(R′O)₃₋ₙSi—Z¹—N(H)—(CH₂)ₘ—NH₂
in which each R′ may be the same or different and is an alkyl group containing from 1 to 10 carbon atoms, n is 0 or 1, Z¹ is a linear or branched alkylene group having from 2 to 10 carbon atoms, m is from 2 to 10. Each R′ may be the same or different and is an alkyl group containing from 1 to 10 carbon atoms, alternatively an alkyl group containing from 1 to 6 carbon atoms, alternatively from 1 to 4 carbon atoms, alternatively is a methyl or ethyl group. In one alternative at least two R′ groups are the same, alternatively all R′ groups are the same. When at least two R′ groups alternatively all R′ groups are the same, it is preferred if they are methyl or ethyl groups. There may be 0 or 1 n groups. Z¹ is a linear or branched alkylene group having from 2 to 10 carbons, alternatively from 2 to 6 carbons, for example Z¹ may be a propylene group, a butylene group or an isobutylene group. There may be from 2 to 10 m groups, in one alterative m may be from 2 to 6, in another alternative m may be from 2 to 5, in a still further alternative m may be 2 or 3, alternatively m is 2. Specific examples include but are not limited to (ethylenediaminepropyl) trimethoxysilane (N[3-(Trimethoxysilyl)propyl]ethylenediamine) and (ethylenediaminepropyl) triethoxysilane. N-(2-aminoethyl)-3-aminoisobutylmethyldimethoxysilane.

The adhesion promoter (e) is optionally present in an amount of from 0 to 3% by weight of the composition, alternatively in an amount of from 0 to 2% by weight of the composition, alternatively in an amount of from 0 to 1% by weight of the composition 0.1 to 1% by weight of the composition.

Reactive silane (f), when present, function as cross-linkers. Reactive silane (f), may be selected from a silane having the structure

R⁸ⱼSi(OR⁵)₄₋ⱼ
where each R⁵ may be the same or different and is an alkyl group containing at least one carbon, alternatively from 1 to 20 carbons, alternatively from 1 to 10 carbons alternatively from 1 to 6 carbons. The value of j is 0 or 1. Whilst each R⁵ group may be the same of different it is preferred that at least two R⁵ groups are the same, alternatively at least three R⁵ groups are the same and alternatively when j is 0 all R⁵ groups are the same. Hence, specific examples of reactive silane (f) when j is zero include tetraethylorthosilicate, tetrapropylorthosilicate, tetra(n-)butylorthosilicate and tetra(t-)butylorthosilicate.

When j is 1 the group R⁸ is present. R⁸ is a silicon-bonded organic group selected from a substituted or unsubstituted straight or branched monovalent hydrocarbon group having at least one carbon, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group, an isocyanurate group or an isocyanate group. Unsubstituted monovalent hydrocarbon groups, suitable as R⁸, may include alkyl groups e.g. methyl, ethyl, propyl, and other alkyl groups, alkenyl groups such as vinyl, cycloalkyl groups may include cyclopentane groups and cyclohexane groups. Substituted groups suitable in or as R⁸, may include, for the sake of example, 3-hydroxypropyl groups, 3-(2-hydroxyethoxy)alkyl groups, halopropyl groups, 3-mercaptopropyl groups, trifluoroalkyl groups such as 3,3,3-trifluoropropyl, 2,3-epoxypropyl groups, 3,4-epoxybutyl groups, 4,5-epoxypentyl groups, 2-glycidoxyethyl groups, 3-glycidoxypropyl groups, 4-glycidoxybutyl groups, 2-(3,4-epoxycyclohexyl) ethyl groups, 3-(3,4-epoxycyclohexyl)alkyl groups, aminopropyl groups, N-methylaminopropyl groups, N-butylaminopropyl groups, N,N-dibutylaminopropyl groups, 3-(2-aminoethoxy)propyl groups, methacryloxyalkyl groups, acryloxyalkyl groups, carboxyalkyl groups such as 3-carboxypropyl groups, 10-carboxydecyl groups.

Specific examples of suitable reactive silane (f) include but are not limited to vinyltrimethoxysilane, methyltrimethoxysilane, ethyltriethoxysilane, ethyltrimethoxysilane, propyltriethoxysilane, isobutyltriethoxysilane, isobutyltrimethoxysilane, vinyltriethoxysilane, phenyltriethoxysilane, phenyltrimethoxysilane, methyltris(isopropenoxy)silane or vinyltris(isopropenoxy)silane, 3-hydroxypropyl triethoxysilane, 3-hydroxypropyl trimethoxysilane, 3-(2-hydroxyethoxy)ethyltriethoxysilane, 3-(2-hydroxyethoxy)ethyltrimethoxysilane, chloropropyl triethoxysilane, 3-mercaptopropyl triethoxysilane, 3,3,3-trifluoropropyl triethoxysilane, 2,3-epoxypropyl triethoxysilane, 2,3-epoxypropyl trimethoxysilane, 3,4-epoxybutyl triethoxysilane, 3,4-epoxybutyl trimethoxysilane, 4,5-epoxypentyl triethoxysilane, 4,5-epoxypentyl trimethoxysilane, 2-glycidoxyethyl triethoxysilane, 2-glycidoxyethyl trimethoxysilane, 3-glycidoxypropyl triethoxysilane, 3-glycidoxypropyl trimethoxysilane, 4-glycidoxybutyl triethoxysilane, 4-glycidoxybutyl trimethoxysilane, 2-(3,4-epoxycyclohexyl) ethyl triethoxysilane, 3-(3,4-epoxycyclohexyl)ethyl triethoxysilane, aminopropyl triethoxysilane, aminopropyl trimethoxysilane, N-methylaminopropyl triethoxysilane, N-methylaminopropyl trimethoxysilane, N-butylaminopropyl trimethoxysilane, N,N-dibutylaminopropyl triethoxysilane, 3-(2-aminoethoxy)propyl triethoxysilane, methacryloxypropyl triethoxysilane, tris(3-triethoxysilylpropyl) isocyanurate, acryloxypropyl triethoxysilane, 3-carboxypropyl triethoxysilane and 10-carboxydecyl triethoxysilane.

The reactive silanes (f) is optionally present in an amount of from 0 to 3% by weight of the composition.

Optional additives may be used if necessary. These may include non-reinforcing fillers, pigments, rheology modifiers, cure modifiers, and fungicides and/or biocides and the like; It will be appreciated that some of the additives are included in more than one list of additives. Such additives would then have the ability to function in all the different ways referred to.

Non-reinforcing fillers, which might be used alone or in addition to the above include aluminite, calcium sulphate (anhydrite), gypsum, nepheline, svenite, quartz, calcium sulphate, magnesium carbonate, clays such as kaolin, ground calcium carbonate, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅.

The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂AI₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate ester, stearic acid, salts of stearic acid, calcium stearate and carboxylatepolybutadiene. Treating agents based on silicon containing materials may include organosilanes, organosiloxanes, or organosilazanes hexaalkyl disilazane or short chain siloxane diols to render the filler(s) hydrophobic and therefore easier to handle and obtain a homogeneous mixture with the other sealant components. The surface treatment of the fillers makes the ground silicate minerals easily wetted by the silicone polymer. These surface modified fillers do not clump, and can be homogeneously incorporated into the silicone polymer. This results in improved room temperature mechanical properties of the uncured compositions. Furthermore, the surface treated fillers give a lower conductivity than untreated or raw material.

The composition of the invention can also include other ingredients known for use in moisture curable compositions based on silicon-bonded hydroxyl or hydrolysable groups such as sealant compositions.

Pigments are utilized to color the composition as required. Any suitable pigment may be utilized providing it is compatible with the composition. When present, carbon black will function as both a non-reinforcing filler and colorant and is present in a range of from 1 to 30% by weight of the catalyst package composition, alternatively from 1 to 20% by weight of the catalyst package composition; alternatively, from 5 to 20% by weight of the catalyst package composition, alternatively from 7.5 to 20% by weight of the catalyst composition.

Rheology modifiers which may be incorporated in moisture curable compositions according to the invention include silicone organic co-polymers such as those described in EP0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion to substrates, particularly plastic substrates.

Biocides may additionally be utilized in the composition if required. It is intended that the term “biocides” includes bactericides, fungicides and algicides, and the like. Suitable examples of useful biocides, which may be utilized in compositions as described herein, include, for the sake of example:
Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl] methyl]-1H-1,2,4-triazole.

The fungicide and/or biocide may suitably be present in an amount of from 0 to 0.3% by weight of the composition and may be present in an encapsulated form where required such as described in EP2106418.

The ingredients and their amounts are designed to provide a low modulus sealant composition. Low modulus silicone sealant compositions are preferably “gunnable” i.e. they have a suitable extrusion capability i.e. a minimum extrusion rate of 10 ml/min as measured by ASTM C1183-04, alternatively 10 to 1000 mL/min, and alternatively 100 to 1000 mL/min.

The ingredients and their amounts in the sealant composition are selected to impart a movement capability to the post-cured sealant material. The movement capability is greater than 25%, alternatively movement capability ranges from 25% to 50%, as measured by ASTM C719-13.

A sealant composition as hereinbefore described may be a gunnable sealant composition used for
(i) space/gap filling applications;
(ii) seal applications, such as sealing the edge of a lap joint in a construction membrane; or
(iii) seal penetration applications, e.g., sealing a vent in a construction membrane;
(iv) adhering at least two substrates together.
(v) a laminating layer between two substrates to produce a laminate of the first substrate, the sealant product and the second substrate.
In the case of (v) above when used as a layer in a laminate, the laminate structure produced is not limited to these three layers. Additional layers of cured sealant and substrate may be applied. The layer of gunnable sealant composition in the laminate may be continuous or discontinuous.

A sealant composition as hereinbefore described may be applied on to any suitable substrate. Suitable substrates may include, but are not limited to, glass; concrete; brick; stucco; metals, such as aluminium, copper, gold, nickel, silicon, silver, stainless steel alloys, and titanium; ceramic materials; plastics including engineered plastics such as epoxies, polycarbonates, poly(butylene terephthalate) resins, polyamide resins and blends thereof, such as blends of polyamide resins with syndiotactic polystyrene such as those commercially available from The Dow Chemical Company, of Midland, Mich., U.S.A., acrylonitrile-butadiene-styrenes, styrene-modified poly(phenylene oxides), poly(phenylene sulfides), vinyl esters, polyphthalamides, and polyimides; cellulosic substrates such as paper, fabric, and wood; and combinations thereof. When more than one substrate is used, there is no requirement for the substrates to be made of the same material. For example, it is possible to form a laminate of plastic and metal substrates or wood and plastic substrates. After application and cure the elastomeric sealant product is non-staining (clean) with respect to porous substrates like granite, limestone, marble, masonry, metal and composite panels. This is at least partially because the composition does not require a diluent such as an unreactive plasticiser or extender in the composition.

In the case of silicone sealant compositions as hereinbefore described, there is provided a method for filling a space between two substrates so as to create a seal therebetween, comprising:
a) providing a silicone composition as hereinbefore described, and either
b) applying the silicone composition to a first substrate, and bringing a second substrate in contact with the silicone composition that has been applied to the first substrate, or
c) filling a space formed by the arrangement of a first substrate and a second substrate with the silicone composition and curing the silicone composition.

In one alternative, a sealant composition as hereinbefore described may be a self-levelling sealant which may be suitable as a highway sealant. A self-levelling sealant composition means it is “self-levelling” when extruded from a storage container into a horizontal joint; that is, the sealant will flow under the force of gravity sufficiently to provide intimate contact between the sealant and the sides of the joint space. This allows maximum adhesion of the sealant to the joint surface to take place. The self-levelling also does away with the necessity of tooling the sealant after it is placed into the joint, such as is required with a sealant which is designed for use in both horizontal and vertical joints. Hence, the sealant flow sufficiently well to fill a crack upon application. If the sealant has sufficient flow, under the force of gravity, it will form an intimate contact with the sides of the irregular crack walls and form a good bond; without the necessity of tooling the sealant after it is extruded into the crack, in order to mechanically force it into contact with the crack sidewalls.

Self-levelling compositions as described herein are useful as a sealant having the unique combination of properties required to function in the sealing of asphalt pavement. Asphalt paving material is used to form asphalt highways by building up an appreciable thickness of material, such as 20.32 cm, and for rehabilitating deteriorating concrete highways by overlaying with a layer having a thickness of, for example, 10.16 cm.

Asphalt overlays undergo a phenomenon known as reflection cracking in which cracks form in the asphalt overlay due to the movement of the underlying concrete at the joints present in the concrete. These reflection cracks need to be sealed to prevent the intrusion of water into the crack, which will cause further destruction of the asphalt pavement when the water freezes and expands. In order to form an effective seal for cracks that are subjected to movement for any reason, such as thermal expansion and contraction, the seal material must bond to the interface at the sidewall of the crack and must not fail cohesively when the crack compresses and expands. In the case of the asphalt pavement, the sealant must not exert enough strain on the asphalt at the interface to cause the asphalt itself to fail; that is, the modulus of the sealant must be low enough that the stress applied at the bond line is well below the yield strength of the asphalt.

In such instances, the modulus of the cured material is designed to be low enough so that it does not exert sufficient force on the asphalt to cause the asphalt to fail cohesively. The cured material is such that when it is put under tension, the level of stress caused by the tension decreases with time so that the joint is not subjected to high stress levels, even if the elongation is severe.

The composition as hereinbefore described provides a translucent, low modulus silicone sealant which substantially plasticiser free, has high movement capabilities and is non-staining (clean) on construction substrates which may or may not be porous, such as granite, limestone, marble, masonry, glass, metal and composite panels for use as a stain-resistant weather sealing sealant material for construction and the like applications.

The Low modulus nature of the silicone elastomer produced upon cure of the composition described herein makes the elastomer effective at sealing joints which may be subjected to movement for any reason, because compared to other cured sealants (with standard or high modulus) lower forces are generated in the cured sealant body and transmitted by the sealant to the substrate/sealant interface due to expansion or contraction of the joint enabling the cured sealant to accommodate greater joint movement without failing cohesively or interfacially (adhesively) or cause substrate failure.

### EXAMPLES

The viscosity test was performed Brookfield DVIII Ultra with cone 52 under 5 rpm for 2 mins. Compositions were mixed and measured at room temperature (about 25° C.). The tests in accordance with ASTM D412-98a (2002) e1) used dumbbell test pieces.

A silicone masterbatch was prepared using the ingredients in Table 1a. The masterbatch was then used in each example/comparative example in combination with the catalyst indicated in Table 1b below.

TABLE 1a
Silicone Masterbatch

| Ingredients | % weight |
|---|---|
| Trimethoxysilyl-terminated | 46.5 |
| polydimethylsiloxane | |
| having a viscosity of about | |
| 60,000 mPa · s | |
| Vinylmethyldimethoxysilane | 3.0 |
| methylltrimethoxysilane | 0.8 |
| Precipitated calcium carbonate | 30.5 |
| Ground calcium carbonate | 19.2 |

The ground calcium carbonate used was type 203A (4.6 μm) obtained from Qunxin Powder Technology and the precipitated calcium carbonate used in the masterbatch was XTCC 201 (60-70 nm with surface area 20 m²/g) from Xintai Nano Material. It is understood that both fillers were fatty acid treated.

The masterbatch was prepared in a Turello mixer using the following process at room temperature and pressure, unless otherwise indicated:
The trimethoxysilyl-terminated polydimethylsiloxane was first introduced into the mixer and was stirred at 400 revolutions per minute (rpm) the methylvinyldimethoxy silane and methyltrimethoxy silane were then added and the mixture was mixed at 400 rpm for a further 5 min. The precipitated and ground calcium carbonates were then introduced gradually whilst mixing continued at 500 rpm. Once all the calcium carbonate had been introduced and mixed into the composition, the mixing speed was increased to 800 rpm and the mixture was mixed for a further two periods of 15 minutes under vacuum. After this the resulting masterbatch composition was stored until required.

The one-part silicone sealant composition was then prepared by mixing the masterbatch with the remaining ingredients using a Semco mixer in the amounts indicated in Table 1b below.

TABLE 1b
Additional Ingredients added to the Masterbatch

| | Comp. 1 | Ex. 1 | Ex. 2 |
|---|---|---|---|
| Ingredients | (wt. %) | (wt. %) | (wt. %) |
| Silicone master batch | 98.8 | 98.6 | 98.6 |
| Tetra n-butyl titanate (TnBT) | 0.1 | 0.1 | 0.1 |
| N-(2-aminoethyl)-3-aminoisobutyl- | 0.2 | 0.2 | 02 |
| methyldimethoxysilane | | | |
| Standard chelated titanate catalyst | 0.9 | | |
| Catalyst 1 | | 1.1 | |
| Catalyst 2 | | | 1.1 |

The Standard chelated Titanate catalyst was Diisopropoxy-bisethylacetoacetatotitanate supplied in combination with methyltrimethoxysilane in a weight ratio of 4:1;
Catalyst 1 was a mixture of tetra tertiary butyl titanate (TtBT)+Ethylhexanoic acid zinc salt, (Zn(EHA)₂) in a weight ratio of 61:29; and
catalyst 2 was a mixture of diisopropoxy-bisethylacetoacetatotitanate & Ethylhexanoic acid zinc salt, (Zn(EHA)₂) in a weight ratio of 16:9.

The compositions were cured at room temperature and pressure for 7 days after which the physical properties of different examples and comparative examples were then assessed.
The results are summarized in Table 2a below. The tests in accordance with ASTM D412-98a (2002) e1 used dumbbell test pieces.

TABLE 2a
Sealant physical properties after curing

| | Comp. | Ex. | Ex. |
|---|---|---|---|
| General properties | 1 | 1 | 2 |
| Skin over Time (SOT), min (ASTM C679-15) | 18.00 | 19.00 | 19.00 |
| Tack free time (TFT), min (ASTM C679-15) | 47.00 | 47.00 | 53.00 |
| Flow, mm (GB/T 13477.6) | 4.00 | 4.50 | 3.00 |
| Cure in depth (CID) after 1 day (mm) | 1.79 | 1.92 | 1.53 |
| CID after 2 days (mm) | 2.65 | 2.75 | 2.60 |
| Tensile Strength, MPa (Dumbell) | 1.43 | 1.04 | 1.08 |
| ASTM D412-98a (2002)e1) | | | |
| Elongation at Break (%)(ASTM | 609.00 | 792.00 | 862.67 |
| D412-98a (2002)e1) | | | |
| Modulus at 100% extension (MPa)(ASTM | 0.49 | 0.37 | 0.34 |
| D412-98a(2002)e1) | | | |
| Shore A hardness (ASTM C661-15) | 23.80 | 18.60 | 18.15 |

The cure in depth tests were undertaken to determine how far below the surface the sealant had hardened in 24 hours by filling a suitable container (avoiding the introduction of air pockets) with sealant, curing the sealant contained in the container for the appropriate period of time at room temperature (about 23° C.) and about 50% relative humidity. After the appropriate curing time the sample is removed from the container and the height of the cured sample is measured.

It can be seen that example 1 and 2 showed much lower tensile modulus than the comparative which used the traditional titanate catalyst alone while similar curing speed were obtained. As shown in sample preparation, high loading level of N-(2-aminoethyl)-3-aminoisobutylmethyldimethoxysilane were applied as polymer chain extender. However, with normal diisopropoxy-bisethylacetoacetatotitanate as catalyst, the cured sealant failed to meet the low modulus requirement (<0.4 MPa at 100% extension).However, catalysts using (Zn(EHA)₂ as part of the catalyst composition, gave sealant modulus reduced from 0.49 MPa to 0.37 MPa, even lower to 0.34 MPa, with other physical properties meeting performance expectations.

Samples of each example and the comparative were aged for 2 weeks at a temperature of 50° C. and then cured at 23° C. and 50% relative humidity for 7 days prior to assessment of their aging physical properties. The results are provided in Table 2b below.

TABLE 2b
Physical property results after aging

| Aging 50° C. 2 Weeks | Comp. 1 | Ex. 1 | Ex. 2 |
|---|---|---|---|
| Skin over Time (SOT), min | 80.00 | 80.00 | 80.00 |
| (ASTM C679-15) | | | |
| Tack free time (TFT), min | 120.00 | 120.00 | 150-170 |
| (ASTM C679-15) | | | |
| Flow, mm (GB/ T 13477.6) | 2.30 | 2.05 | 2.25 |
| Cure in depth (CID) after 1 day (mm) | 2.84 | 2.63 | 2.56 |
| CID after 2 days (mm) | 2.00 | 2.50 | 2.00 |
| Tensile Strength, (MPa) (ASTM | 1.23 | 0.86 | 1.01 |
| D412-98a(2002)e1) | | | |
| Elongation at Break (%)(ASTM | 872.67 | 889.00 | 947.33 |
| D412-98a(2002)e1) | | | |
| Modulus at 100% extension (MPa) | 0.31 | 0.22 | 0.22 |
| (ASTM D412-98a(2002)e1) | | | |
| Shore A hardness (ASTM C661-15) | 14.90 | 8.60 | 8.40 |

As shown, using catalyst as hereinbefore described results in a reduction in modulus at 100% extension of the one-part alkoxy non-staining (clean) sealant described herein without any sacrifice in the values of other properties. Hence compositions as described herein provide a practical way to make one-part alkoxy non-staining (clean) sealant to meet the low modulus standards.

1. A one-part condensation curable low modulus room temperature vulcanisable (RTV) silicone composition comprising:
(a) an organopolysiloxane polymer having at least two hydroxyl or hydrolysable groups per molecule and of the general formula
X₃₋ₙRₙSi—(Z)_{d}—(O)_{q}—(R¹_{y}SiO_{(4-y)/2})_{z}—(SiR¹₂—Z)_{d}—SiRₙX₃₋ₙ (1)
in which each X is independently a hydroxyl group or a hydrolysable group, each R is an alkyl, alkenyl or aryl group, each R¹ is an X group, alkyl group, alkenyl group or aryl group and Z is a divalent organic group; d is 0 or 1, q is 0 or 1 and (d+q)=1; n is 0, 1, 2 or 3, y is 0, 1 or 2, or optionally y is 2, and z is an integer such that organopolysiloxane polymer (a) has a viscosity of from 30,000 to 80,000 mPa·s at 25° C., or optionally from 40,000 to 75,000 mPa·s at 25° C., in an amount of from 35 to 60% by weight of the composition;
(b) a hydrophobically treated reinforcing filler in an amount of from 30 to 55% by weight of the composition;
(c) one or more difunctional silanes, in an amount of from 0.5 to 5% by weight of the composition;
(d) a catalyst comprising (i) a titanate and/or zirconate and (ii) a metal carboxylate;
(e) an adhesion promoter, in an amount of from 0.1 to 1% by weight of the composition; and
(f) one or more reactive silanes having at least three functional groups in an amount of from 0 to 3% by weight of the composition.

2. The one-part room temperature vulcanisable (RTV) silicone composition in accordance with claim 1, wherein organopolysiloxane polymer (a) is of the general formula
X₃₋ₙRₙSi—(Z)—(R¹_{y}SiO_{(4-y)/2})_{z}—(SiR¹₂—Z)—SiRₙX₃₋ₙ
wherein n is 0 or 1, each of R, Z, R¹, y, and z is as defined above, and each X is an alkoxy group.

3. The one-part room temperature vulcanisable (RTV) silicone composition in accordance with claim 1, wherein catalyst (d) is the metal carboxylate salt (ii) and the metal of the metal carboxylate salt (ii) is selected from the group consisting of zinc, aluminium, bismuth, zirconium, and combinations thereof.

4. The one-part room temperature vulcanisable (RTV) silicone composition in accordance with claim 1, wherein catalyst (d) is the metal carboxylate salt (ii) and is selected from the group consisting of zinc (II) carboxylates, aluminium (III) carboxylates, bismuth (III) carboxylates, zirconium (IV) carboxylates, zinc (II) alkylcarboxylates, aluminium (III) alkylcarboxylates, bismuth (III) alkylcarboxylates, zirconium (IV) alkylcarboxylates, and combinations thereof.

5. The one-part room temperature vulcanisable (RTV) silicone composition in accordance with claim 1, wherein catalyst (d) is the metal carboxylate salt (ii) and is selected from the group consisting of zinc ethylhexanoate, bismuth ethylhexanoate, zinc stearate, zinc undecylenate, zinc neodecanoate, and iron (III) 2-ethylhexanoate.

6. The one-part room temperature vulcanisable (RTV) silicone composition in accordance with claim 1, wherein the titanate and/or zirconate (i) and the metal carboxylate salt (ii) of catalyst (d) is provided in a molar ratio of 1:4 to 4:1.

7. The one-part room temperature vulcanisable (RTV) silicone composition in accordance with claim 1, which is gunnable and/or self-levelling.

8. The one-part room temperature vulcanisable (RTV) silicone composition in accordance with claim 1, capable of being applied as a paste to a joint between two adjacent substrate surfaces where it can be worked, prior to curing, to provide a smooth surfaced mass which will remain in its allotted position until it has cured into an elastomeric body adherent to the adjacent substrate surfaces.

9. A silicone elastomer which is the reaction product of the one-part room temperature vulcanisable (RTV) silicone composition in accordance with claim 1.

10. The silicone elastomer in accordance with claim 9, which upon cure provides a sealant with a low modulus of ≤0.4 MPa at 100% elongation.

11. The silicone elastomer in accordance with claim 9, which is non-staining.

12. A method of making the one-part room temperature vulcanisable (RTV) silicone composition in accordance with claim 1, the method comprising mixing all of the ingredients together.

13. A sealant suitable for use in the facade, insulated glass, window construction, automotive, solar and construction fields, wherein the sealant comprises or is formed from the one-part room temperature vulcanisable (RTV) silicone composition in accordance with claim 1.

14. A method for filling a space between two substrates so as to create a seal therebetween, the method comprising:
a) providing the one-part room temperature vulcanisable (RTV) silicone composition in accordance with claim 1, and either b) or c);
b) applying the silicone composition to a first substrate, and bringing a second substrate in contact with the silicone composition that has been applied to the first substrate, or
c) filling a space formed by the arrangement of a first substrate and a second substrate with the silicone composition and curing the silicone composition.

15. The method for filling a space between two substrates in accordance with claim 14, wherein the space is filled by introducing the silicone composition by way of extrusion or through a sealant gun.
